(19) United States
(12) Patent Application Publication
(10) Pub. No.: US 2009/0151795 A1
(43) Pub. Date: Jun. 18, 2009

(54) ICE TRAY WITH WATER LEVEL DETECTING DEVICE

(76) Inventor: Shih-Hsien HSU, Taipei Hsien (TW)

Correspondence Address: Joe McKinney Muncy, PO Box 1364, Fairfax, VA, 22038-1364, US

(21) Appl. No.: 11/959,279

(22) Filed: Dec. 18, 2007

(51) Int. Cl. B67D 5/08

(52) U.S. Cl. 137/386

(57) ABSTRACT

An ice tray with water level detecting device includes an ice trench and a water level detecting device for detecting the water level of the water in the ice trench. The water level detecting device includes a radio frequency detecting device and a parameter setting unit. The radio frequency detecting device emits a radio frequency wave to the ice tray and the water and receives the reflection wave from the ice tray or the water. Here, the radio frequency detecting device has a decision level for deciding the strength of the reflection wave, so as to output a stop signal to stop the water supplying schedule. And, the parameter setting unit can alter the decision level for changing the water level of the ice tray. Therefore, through the structure described above, the water amount in the ice tray can be detected and controlled in an effective way.

### FIELD OF THE INVENTION

The present invention is related to an ice tray with water level detecting device, and more particularly to a device for detecting the water level in the ice tray.

### BACKGROUND OF THE INVENTION

Ice machine is commonly used by restaurants or the general domestic refrigerators. Generally, the ice machine at least has an ice tray and a water inflow mechanism, wherein the water inflow mechanism is connected to a water source for proving water to the ice tray, then the water in the ice tray waits for being frozen, and the ice cubes are removed for repeating the ice making process. The water supplying speed of the water inflow mechanism is influenced by the pressure of the water source. If the water pressure is too low, the fixed water supplying schedule can not achieve a preset water level in the ice tray, or the water can not reach the end of the ice tray far from the water supplying mechanism, so as to cause the formed ice cubes too small or insufficient. If the water pressure is too high, the supplied water amount after the fixed water supplying schedule might exceed the normal amount, so that not only the ice becomes too big, but the components of the ice tray or the ice machine also might be damaged owing to the frozen of the overflowed water. R.O.C. Patent No. I277715, entitled “Automatic ice making device and refrigerator with thereof”, includes an ice tray and a water storage tank, and also a water pump for providing the water in the water-storage tank to the ice tray. The action of the water pump is controlled by a sensor, which is used to detect the position of the ice tray. But, this patent does not provide the method and structure for controlling water supply. Furthermore, in R.O.C. Patent No. I274133, entitled “Refrigerator”, the water inflow mechanism controls the working time of a water pump for altering the water amount, so that there is no mechanism for detecting the water level, and if the pressure of the water source is unstable, then the water level in the ice tray might not be controlled accurately. Therefore, there is the need to improve thereof.

### SUMMARY OF THE INVENTION

Consequently, the object of the present invention is to provide an ice machine structure capable of detecting water level.

The present invention provides an ice tray with water level detecting device including an ice trench for accommodating water to be frozen and a water inflow mechanism for supplying water to the ice tray, and further including a water level detecting device for detecting the water level of the water in the ice trench. The water level detecting device includes a radio frequency detecting device and a parameter setting unit. The radio frequency detecting device emits a radio frequency wave to the ice tray and the water and receives the reflection wave from the ice tray or the water. Here, the radio frequency detecting device has a decision level for deciding the strength of the reflection wave, so as to output a stop signal to stop the water supplying schedule. And, the parameter setting unit can alter the physical property of the radio frequency emitting wave by setting the emitting parameter of the radio frequency setting unit, and through changing the decision level, the water level of the ice tray can be altered. Therefore, through the structure described above, the water amount in the ice tray can be detected and controlled in an effective way.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three dimension drawing showing an ice machine with a water level detecting device;

FIG. 2 is a block diagram showing the architecture of an embodiment according to the present invention;

FIG. 3 is a sectional view showing the ice machine according to the present invention;

FIG. 4 is a schematic view showing the present invention; and

FIG. 5 is another schematic view showing the present invention.

### DESCRIPTION OF THE PREFERRED EMBODIMENT

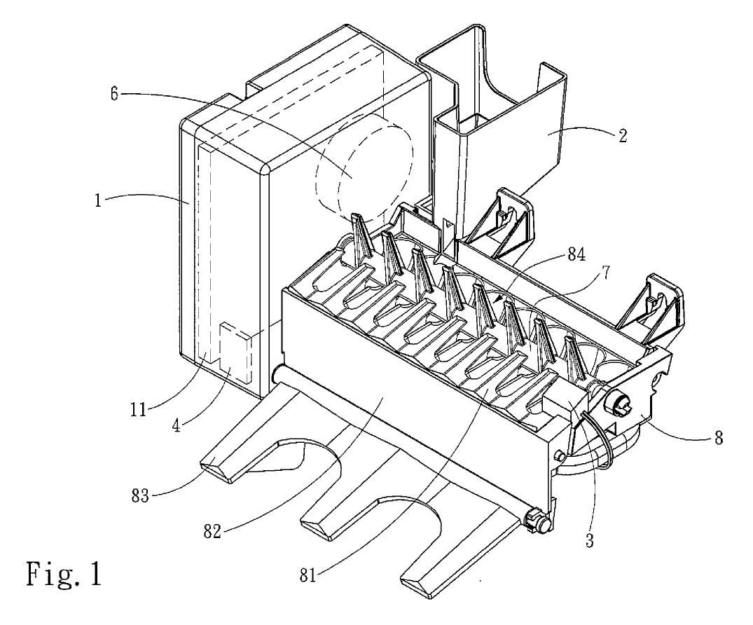

Please refer to FIG. 1, which is a three dimension drawing showing an ice tray with a water level detecting device. The ice machine includes an ice tray 8, a water inflow mechanism 2 for supplying water from one end of the ice tray 8, an ice sweep shaft 7 for removing the ice cubes in the ice tray 8, and a control box 1. The control box 1 has, accommodated therein, a driving motor 6 for driving the ice sweep shaft 7 to execute the ice sweeping, and a control unit 11. The ice tray 8 has at least an ice trench 84 for accommodating the water, which waits for being frozen, and the ice tray 8 has a water level detecting device mounted thereon for detecting the water level of the water accommodated in the ice trench 84. The water level detecting device includes a radio frequency detecting device 3 and a parameter setting unit 4. Besides, for guiding the ice cubes to move, the ice tray 8 further includes, at the upper edge thereof, a first guiding board 81, a blocking board 82 and a second guiding board 83, and the radio-frequency detecting device 3 can be mounted on the first guiding board 81. When there is no water in the ice tray 8 or the ice making process is finished, according to a fixed schedule, the control unit 11 can produce a driving signal and a water inflow signal for respectively initiating the driving motor 6 to move the ice sweep shaft 7 and initiating the water inflow mechanism 2 to supply water to the ice tray 8. The water inflow mechanism 2 supplies water from one end of the ice tray 8, and the radio frequency detecting device 3 is mounted at the opposite end to the water inflow mechanism 2. When the water inflow mechanism 2 starts and continues to supply water, the radio frequency detecting device 3 initiates to detect the water surface and outputs a stop signal as the water surface reaches a preset level. When the control unit 11 receives the stop signal, it will stop the schedule for outputting the water inflow signal so as to stop water supplying of the water inflow mechanism 2. Then, the water in the ice tray 8 waits for being frozen. After that, the ice making process can be restart again.

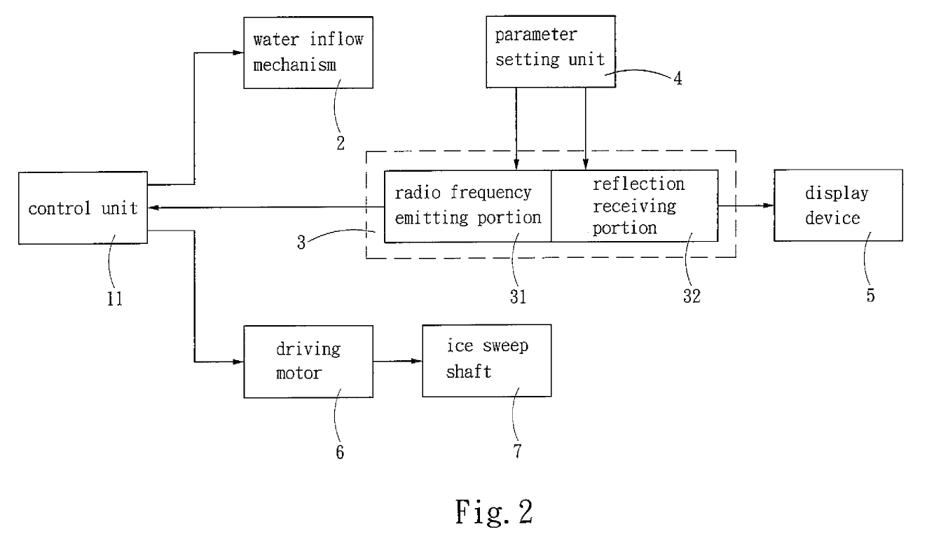

Please refer to FIG. 2, which is a block diagram showing the architecture of an embodiment according to the present invention. The radio frequency detecting device 3 includes a radio frequency emitting portion 31 for emitting the radio frequency wave to the ice tray 8 and the water, and a reflection receiving portion 32 for receiving the reflection wave from the ice tray 8 and the water. After the reflection receiving portion 32 receives the reflection wave, the reflection wave will be converted into an electric signal. Then, the radio frequency detecting device 3 will decide that if the electric signal reaches a decision level, which is preset in the radio frequency device 3, and when the strength of the reflection wave reaches the decision level, the radio frequency detecting device will produce a stop signal to send out to the control unit 11. After the control unit 11 receives the stop signal, it stops outputting the water inflow signal, so as to stop the water supply from the water inflow mechanism 2. Here, the electric signal converted from the reflection wave received by the reflection receiving portion 32 can be an electric voltage signal or an electric current signal which can be non-continuous pulse wave signal or continuous linear signal, and the decision level also can correspondingly be an electric voltage level or an electric current level. Moreover, the parameter setting unit 4 has a power source with adjustable electricity output for providing the radio frequency detecting device 3 to adjust the decision level and to set the emitting parameter of the radio frequency emitting portion 31, so as to adjust the sensitivity of the radio frequency detecting device 3 and adjust the corresponding height of water level through changing the decision level. Furthermore, the radio frequency detecting device 3 is connected to a display device 5 for displaying if the reflection wave reaches the decision level, wherein the display device 5 can be an LED (Light Emitting Diode) or an LCD (Liquid Crystal Display). Besides, the radio frequency detecting device 3 can be infrared ray detecting device or an ultrasonic detecting device. The emitting parameter set by the parameter setting unit 4 can be the power magnitude or the frequency of the radio frequency emitting wave or the wavelength of the radio frequency emitting wave, so that the parameter setting unit 4 can set the water supplying amount through adjusting the emitting parameter of the radio frequency detecting device 3 and the decision level.

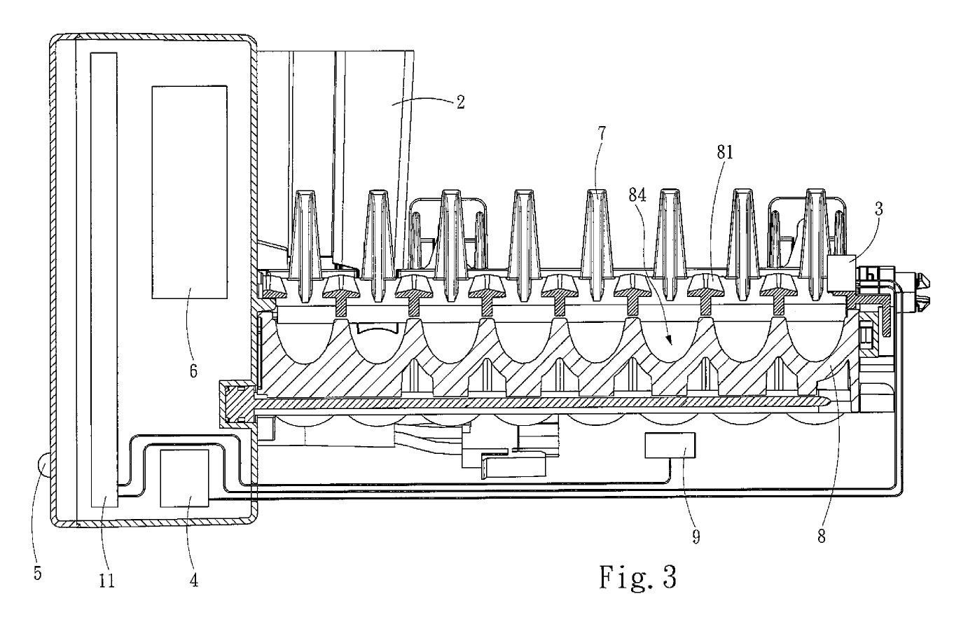

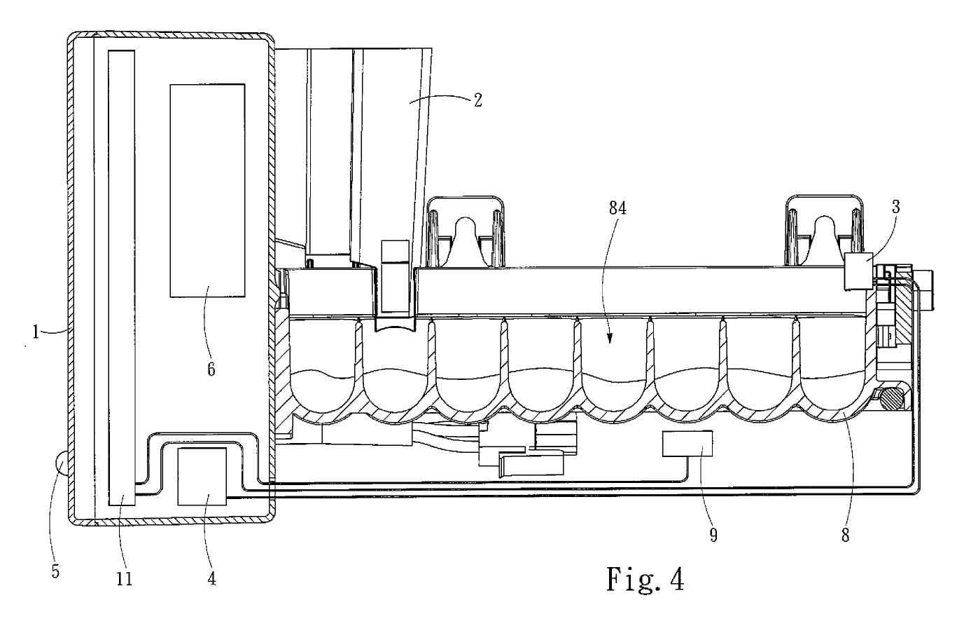

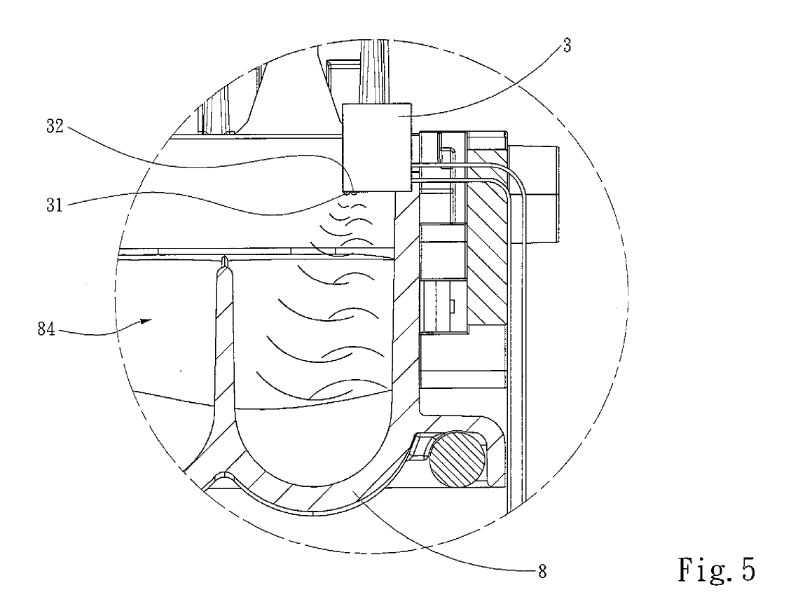

Please refer to FIG. 3, FIG. 4 and FIG. 5, Under the ice tray 8, a temperature sensing unit 9 can be further mounted. The temperature sensing unit 9 can sense if the temperature of the ice tray 8 reaches a preset frozen temperature, and if yes, it will output a finish signal to the control unit 11, so as to decide the schedule of the control unit 11 for outputting the driving signal. That is, after noticing the formation of ice cubes through sensing the temperature, the control unit 11 produces the driving signal to the driving motor 6 for driving the ice sweep shaft 7 to remove the cubes in the ice tray 8. Then, the control unit 11 produces the water inflow signal to initiate the water inflow mechanism 2, so as to inflow water from one end of the ice tray 8. After the water inflow starts, the radio frequency emitting portion 31 of the radio frequency detecting device 3 emits a radio frequency emitting wave and then the reflection receiving portion 32 receives a reflection wave for deciding if the water level is reached. As the water level getting higher, the strength of the reflection wave gradually reaches the decision level, so that the radio frequency detecting device 3 produces the stop signal to the water inflow mechanism 2 for stopping water supplying. Then, the water in the ice tray 8 waits for being frozen. After the cubes are removed, the ice making process is repeated. Furthermore, the display device 5 can display the water inflow condition of the ice tray. The display device 5 can be an LED (light Emitting Diode), so that the reaching of the preset water level can be indicated by the illumination variation of LED. Or, the display device 5 also can be an LCD (Liquid Crystal Display) for displaying the height of the water surface which is decided by the radio frequency detecting device 3.

In the embodiment described above, the control unit 11 can be an integrated circuit board, and the control unit 11 and the radio frequency detecting device 3 can respectively have a wireless transceiver module mounted therein for wirelessly transmitting signals therebetween, so that the wired connection can be eliminated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An ice tray with water level detecting device, comprising at least an ice trench for accommodating water to wait for being frozen, wherein the ice tray is supplied by a water inflow mechanism, which is connected to a control unit, the control unit outputs a water inflow signal to initiate the water inflow mechanism for supplying water to the ice tray, and the ice tray further comprises a water level detecting device, the water level detecting device comprising:
a radio frequency detecting device, mounted on the ice tray, having a radio frequency emitting portion for emitting a radio frequency wave to the ice tray and the water therein, and a reflection receiving portion for receiving a reflection wave from the ice tray and the water, wherein the radio frequency detecting device further have a decision level for deciding the strength of the reflection wave, so as to produce a stop signal to the control unit for stopping water supplying as the decision level is achieved; and
a parameter setting unit, for setting an emitting parameter of the radio frequency emitting portion, so as to adjust the decision level.

2. The ice tray with water level detecting device as claimed in claim 1, wherein the radio frequency detecting device is mounted on the ice tray at an opposite end to the end of the water inflow mechanism.

3. The ice tray with water level detecting device as claimed in claim 2, wherein the control unit and the radio frequency detecting device respectively have a wireless transceiver module for wirelessly transmitting signals.

4. The ice tray with water level detecting device as claimed in claim 1, wherein the radio frequency detecting device is an infrared ray detecting device.

5. The ice tray with water level detecting device as claimed in claim 1, wherein the radio frequency detecting device is an ultrasonic detecting device.

6. The ice tray with water level detecting device as claimed in claim 1, wherein the reflection receiving portion generates an electric voltage signal according to the magnitude of the reflection wave.

7. The ice tray with water level detecting device as claimed in claim 6, wherein the decision level is a preset voltage level.

8. The ice tray with water level detecting device as claimed in claim 1, wherein the reflection receiving portion generates an electric current signal according to the magnitude of the reflection wave.

9. The ice tray with water level detecting device as claimed in claim 8, wherein the decision level is a preset current level.

10. The ice tray with water level detecting device as claimed in claim 1, wherein radio frequency detecting device is further connected to a display device for displaying if the reflection wave reaches the decision level.

11. The ice tray with water level detecting device as claimed in claim 10, wherein the display device is an LED (Light Emitting Diode).

12. The ice tray with water level detecting device as claimed in claim 10, wherein the display device is an LCD (Liquid Crystal Display).

13. The ice tray with water level detecting device as claimed in claim 1, wherein the emitting parameter of the radio frequency emitting portion is the power magnitude of the radio frequency emitting wave.

14. The ice tray with water level detecting device as claimed in claim 1, wherein the emitting parameter of the radio frequency emitting portion is the wavelength of the radio frequency emitting wave.

15. The ice tray with water level detecting device as claimed in claim 1, wherein the emitting parameter of the radio frequency emitting portion is the frequency of the radio frequency emitting wave.

16. The ice tray with water level detecting device as claimed in claim 1, wherein the parameter setting unit has a power source with adjustable output electricity for providing to the radio frequency detecting device to adjust the decision level.
